(19) United States
(12) Patent Application Publication
(10) Pub. No.: US 2016/0167526 A1
(43) Pub. Date: Jun. 16, 2016

(54) HYBRID VEHICLE AND METHOD OF CONTROLLING HYBRID VEHICLE

(71) Applicant: HYUNDAI MOBIS Co., Ltd., Yongin-si (KR)

(72) Inventor: Jin Moo JEON, Yongin-si (KR)

(73) Assignee: HYUNDAI MOBIS Co., Ltd., Yongin-si (KR)

(21) Appl. No.: 14/956,814

(22) Filed: Dec. 2, 2015

(30) Foreign Application Priority Data
Dec. 15, 2014 (KR) 10-2014-0180384

(51) Int. Cl. B60L 7/16; H02K 7/02; B60K 6/20

(52) U.S. Cl. CPC B60L 7/16; B60K 6/20; H02K 7/025; Y10S 903/903; B60Y 2200/10; B60Y 2300/60; B60Y 2400/20

(57) ABSTRACT

Provided is a hybrid vehicle and a method of controlling the hybrid vehicle which may assist an engine without using a battery. To this end, according to the hybrid vehicle and the method of controlling the hybrid vehicle according to the exemplary embodiment of the present invention, a second motor unit generates first rotational force by using first electricity produced by a first motor unit for rotating a first wheel and produces second electricity, and the first motor unit generates second rotational force by using the second electricity and rotates the first wheel.

### CROSS-REFERENCE TO RELATED APPLICATIONS

The present application claims priority to Korean Patent Application Number 10-2014-0180384 filed Dec. 15, 2014, the entire contents of which the application is incorporated herein for all purposes by this reference.

### TECHNICAL FIELD

The present invention relates to a hybrid vehicle and a method of controlling the hybrid vehicle, and more particularly, to a hybrid vehicle in which a motor for assisting an internal combustion engine is installed, and a method of controlling the hybrid vehicle.

### BACKGROUND

As fossil fuel is being exhausted, an electric vehicle, which drives a motor by using electrical energy stored in a battery, is being developed instead of a vehicle that uses fossil fuel such as gasoline and diesel fuel.

The electric vehicle is classified into a pure electric vehicle which drives a motor by using only electrical energy stored in a charged battery, a solar cell vehicle which drives a motor by using photocells, a fuel cell vehicle which drives a motor by using a fuel cell that uses hydrogen fuel, and a hybrid vehicle which uses both an engine and a motor by using fossil fuel to drive the engine and by using electricity to drive the motor.

However, since the hybrid vehicle needs to have the battery charged with electricity in order to drive the motor, a space in which the battery is installed is required, and as a result, a space in the interior of the vehicle becomes narrow.

### SUMMARY

The present invention has been made in an effort to provide a hybrid vehicle capable of assisting an engine without using a battery, and a method of controlling the hybrid vehicle.

Technical problems of the present invention are not limited to the aforementioned technical problem, and other technical problems, which are not mentioned above, may be clearly understood by those skilled in the art from the following descriptions.

An exemplary embodiment of the present invention provides a hybrid vehicle including: a first motor unit which rotates a first wheel and produces first electricity; and a second motor unit which generates first rotational force by using the first electricity, and generates second electricity by using the first rotational force, in which the first motor unit generates second rotational force by using the second electricity, and rotates the first wheel.

Another exemplary embodiment of the present invention provides a method of controlling a hybrid vehicle, the method including: producing, by a first motor unit, first electricity for rotating a first wheel; generating, by a second motor unit, first rotational force by using the first electricity; producing, by the second motor unit, second electricity by using the first rotational force; and generating, by the first motor unit, second rotational force by using the second electricity and rotating the first wheel.

Other detailed matters of the exemplary embodiment are included in the detailed description and the drawings.

The hybrid vehicle according to the exemplary embodiment of the present invention and the method of controlling the hybrid vehicle may assist an engine without using a battery.

The effect of the present invention is not limited to the aforementioned effect, and other effects, which are not mentioned above, will be clearly understood by those skilled in the art from the claims.

### BRIEF DESCRIPTION OF THE DRAWINGS

FIG. 1 is a view illustrating a first vehicle wheel and a second vehicle wheel of a hybrid vehicle according to an exemplary embodiment of the present invention.

FIG. 2 is a cross-sectional view illustrating the inside of the first vehicle wheel and the second vehicle wheel illustrated in FIG. 1.

FIG. 3 is an enlarged view of the first vehicle wheel illustrated in FIG. 2.

FIG. 4 is an enlarged view of the second vehicle wheel illustrated in FIG. 2.

FIG. 5 is a control block diagram illustrating the hybrid vehicle according to the exemplary embodiment of the present invention.

FIG. 6 is a flowchart according to a method of controlling the hybrid vehicle according to the exemplary embodiment of the present invention.

### DETAILED DESCRIPTION

Advantages and features of the present invention and methods of achieving the advantages and features will be clear with reference to exemplary embodiments described in detail below together with the accompanying drawings. However, the present invention is not limited to the exemplary embodiments set forth below, and may be embodied in various other forms. The present exemplary embodiments are for rendering the disclosure of the present invention complete and are set forth to provide a complete understanding of the scope of the invention to a person with ordinary skill in the technical field to which the present invention pertains, and the present invention will only be defined by the scope of the claims. Like reference numerals indicate like elements throughout the specification.

Hereinafter, a hybrid vehicle and a method of controlling the hybrid vehicle according to an exemplary embodiment of the present invention will be described with reference to the drawings.

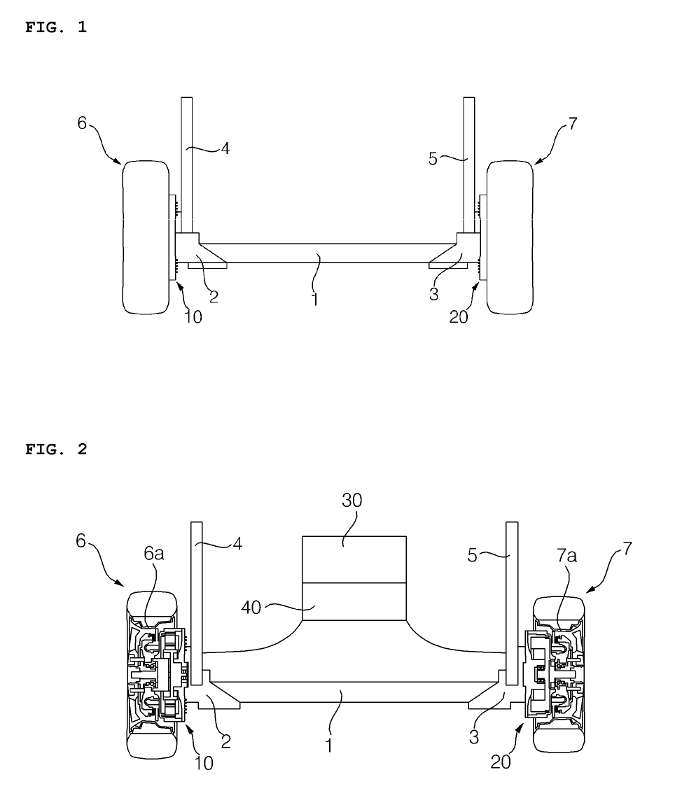

FIG. 1 is a view illustrating a first vehicle wheel and a second vehicle wheel of a hybrid vehicle according to an exemplary embodiment of the present invention.

Referring to FIG. 1, the hybrid vehicle according to the exemplary embodiment of the present invention includes a cross member 1 which is disposed at a rear lower side of the hybrid vehicle and elongated in a left and right direction, a first lower arm 2 which is coupled to a left side of the cross member 1, a second lower arm 3 which is coupled to a right side of the cross member 1, a first vehicle wheel 6 which is disposed at a rear left side of the hybrid vehicle and rotated so that the hybrid vehicle travels, and a second vehicle wheel 7 which is disposed at a rear right side of the hybrid vehicle and rotated so that the hybrid vehicle travels.

A first damper 4, which supports a vehicle body, is installed on the first lower arm 2. The first damper 4 has an upper end coupled to the vehicle body and a lower end coupled to the first lower arm 2, and absorbs vibration transmitted from a road surface through the first vehicle wheel 6. The first damper 4 may have a spring to absorb vibration.

A second damper 5, which supports the vehicle body, is installed on the second lower arm 3. The second damper 5 has the same configuration and function as the first damper 4. That is, the second damper 5 has an upper end coupled to the vehicle body and a lower end coupled to the second lower arm 3, and absorbs vibration transmitted from the road surface through the second vehicle wheel 7. The second damper 5 may have a spring to absorb vibration.

The first vehicle wheel 6 and the second vehicle wheel 7 are disposed relative to each other in the left and right direction. However, the first vehicle wheel 6 means a wheel in which a first motor unit 10 is installed, that is, a wheel that is rotated by rotational force generated by the first motor unit 10. For example, in a case in which the first motor units 10 are installed in all of a front left wheel, a front right wheel, a rear left wheel, and a rear right wheel of the vehicle, the first vehicle wheels 6 may mean all of the front left wheel, the front right wheel, the rear left wheel, and the rear right wheel. In the present exemplary embodiment, the first motor unit 10 is installed in the first vehicle wheel 6, and a second motor unit 20 is installed in the second vehicle wheel 7. The first motor unit 10 is coupled to a left side of the first lower arm 2 and connects the first vehicle wheel 6 and the first lower arm 2, and the second motor unit 20 is coupled to a right side of the second lower arm 3 and connects the second vehicle wheel 7 and the second lower arm 3.

The first motor unit 10 and the second motor unit 20 are driven by electricity. In addition, the first motor unit 10 and the second motor unit 20 produce electricity. Hereinafter, electricity produced by the first motor unit 10 is referred to as first electricity, and electricity produced by the second motor unit 20 is referred to as second electricity.

The first motor unit 10 is driven to rotate the first vehicle wheel 6 and installed in the first vehicle wheel 6.

However, the installation position of the first motor unit 10 may be variously changed as long as the first motor unit 10 may rotate the first vehicle wheel 6. The first motor unit 10 is driven by using the second electricity produced by the second motor unit 20 and rotates the first vehicle wheel 6.

The second motor unit 20 is driven by using the first electricity produced by the first motor unit 10 and produces the second electricity. That is, the second motor unit 20 does not serve to rotate the second vehicle wheel 7, but converts electrical energy produced by the first motor unit 10 into kinetic energy, and then, in a case in which the first motor unit 10 is driven to rotate the first vehicle wheel 6, the second motor unit 20 converts the kinetic energy back into electrical energy. The second motor unit 20 is installed in the second vehicle wheel 7. However, the installation position of the second motor unit 20 may be variously changed. For example, in a case in which the first motor units 10 are installed in all of the front left wheel, the front right wheel, the rear left wheel, and the rear right wheel, the second motor unit 20 may be installed at a location other than the front left wheel, the front right wheel, the rear left wheel, and the rear right wheel. Hereinafter, the second motor unit 20 to be described is limited to being installed in the second vehicle wheel 7.

FIG. 2 is a cross-sectional view illustrating the inside of the first vehicle wheel and the second vehicle wheel illustrated in FIG. 1.

Referring to FIG. 2, the first motor unit 10 is disposed to be inserted into a wheel 6a of the first vehicle wheel 6, and the second motor unit 20 is disposed to be inserted into a wheel 7a of the second vehicle wheel 7. Hereinafter, the wheel 6a of the first vehicle wheel 6 is referred to as a first wheel 6a, and the wheel 7a of the second vehicle wheel 7 is referred to as a second wheel 7a.

The hybrid vehicle according to the exemplary embodiment of the present invention further includes an inverter 30 that controls the first motor unit 10 and the second motor unit 20. The inverter 30 controls the first motor unit 10 so that the first motor unit 10 produces the first electricity by using regenerative braking force when the hybrid vehicle is braked while traveling, and controls the second motor unit 20 so that the second motor unit 20 produces the second electricity when the hybrid vehicle accelerates after being braked.

The hybrid vehicle according to the exemplary embodiment of the present invention further includes an energy distributor 40 that supplies the second motor unit 20 with the first electricity produced by the first motor unit 10 when the hybrid vehicle is braked while traveling, and supplies the first motor unit 10 with the second electricity produced by the second motor unit 20 when the hybrid vehicle accelerates after being braked.

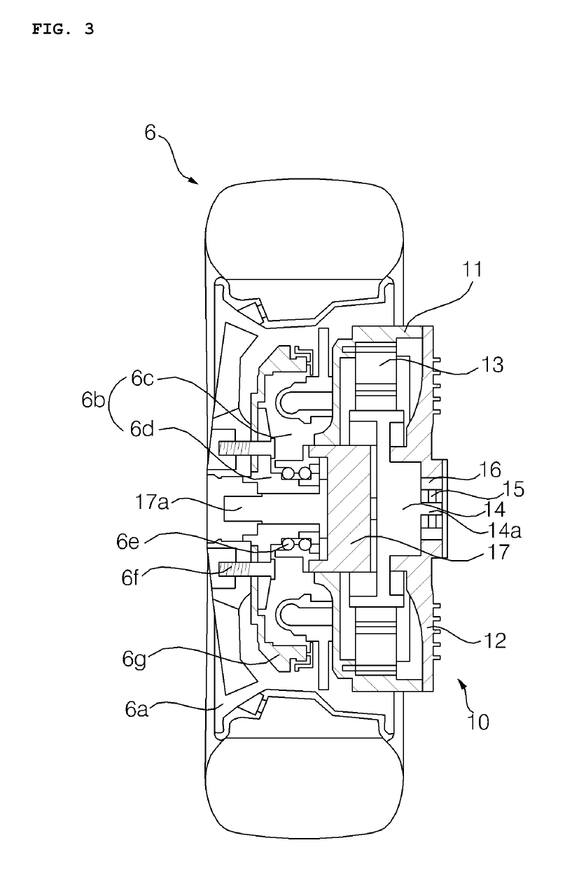

FIG. 3 is an enlarged view of the first vehicle wheel illustrated in FIG. 2.

Referring to FIGS. 2 and 3, the first motor unit 10 includes a first housing 11 which is at least partially inserted into the first wheel 6a, a first stator 13 which is fixed in the first housing 11, and a first rotor 14 which is rotatably disposed inside the first stator 13.

The first housing 11 is formed to have a vacant structure, and the first stator 13 and the first rotor 14 are accommodated in a vacant internal space of the first housing 11. A right side of the first housing 11 is fully opened, and a first cover 12 is coupled to the opened right side. The first cover 12 is coupled to the first housing 11 while covering the opened right side of the first housing 11. The first cover 12 may be coupled to and supported by the first lower arm 2.

When the energy distributor 40 supplies the second electricity to the first motor unit 10, the first rotor 14 is rotated by a magnetic field formed between the first rotor 14 and the first stator 13. A rotating shaft 14a of the first rotor 14 protrudes at left and right sides of the first rotor 14. The rotating shaft 14a of the first rotor 14 may be understood as the same as the rotating shaft 14a of the first motor unit 10.

A right side of the rotating shaft 14a of the first rotor 14 is rotatably coupled to the first cover 12. The right side of the rotating shaft 14a of the first rotor 14 may be rotatably coupled to the first cover 12 by means of a bearing 15. A resolver 16 is installed at the right side of the rotating shaft 14a of the first rotor 14. The resolver 16 detects rotational force, a speed, and a position of the first rotor 14, and provides information to the inverter 30.

A left side of the rotating shaft 14a of the first rotor 14 may be coupled to a first hub 6b to rotate the first hub 6b. Here, the first hub 6b is coupled inside the first wheel 6a by bolts 6f and rotated simultaneously together with the first rotor 14 by rotational force of the first rotor 14, such that the first wheel 6a may be rotated. However, in the present exemplary embodiment, the right side of the rotating shaft 14a of the first rotor 14 is not directly coupled to the first hub 6b, but is coupled to the first hub 6b through a speed reducer 17.

The speed reducer 17 is coupled to the rotating shaft 14a of the first rotor 14 and the first hub 6b, increases torque received from the first rotor 14, and transmits torque to the first hub 6b. That is, when the first rotor 14 is rotated, the speed reducer 17 is rotated simultaneously together with the first rotor 14 by using rotational force of the first rotor 14 to generate rotational force, and the first hub 6b is rotated by the rotational force generated by the speed reducer 17, such that the first wheel 6a may be rotated simultaneously together with the first rotor 14.

The first hub 6b includes a first outer wheel 6c which is fixedly coupled to the first housing 11, and a first inner wheel 6d which is rotatably coupled inside the first outer wheel 6c by means of a bearing 6e. The first inner wheel 6d is coupled to the first wheel 6a by the bolts 6f.

A center at a left side of the first housing 11 is opened. The speed reducer 17 is disposed to be inserted into the opened left side of the first housing 11. A rotating shaft 17a protrudes at a left side of the speed reducer 17. The rotating shaft 14a of the first rotor 14 is inserted into and coupled to a right side of the speed reducer 17, and the rotating shaft 17a at the left side of the speed reducer 17 is inserted into the first inner wheel 6d of the first hub 6b and coupled to the first inner wheel 6d. Therefore, the first inner wheel 6d is rotated by rotational force transmitted from the speed reducer 17, thereby rotating the first wheel 6a.

Meanwhile, when the first inner wheel 6d is coupled to the first wheel 6a by the bolts 6f, the first inner wheel 6d and the first wheel 6a are coupled together with a first brake 6g. That is, a portion of the first brake 6g, which is disposed between the first wheel 6a and the first inner wheel 6d, is coupled by the bolts 6f. When a driver presses a brake pedal, the first brake 6g causes friction with the first outer wheel 6c to brake the first wheel 6a.

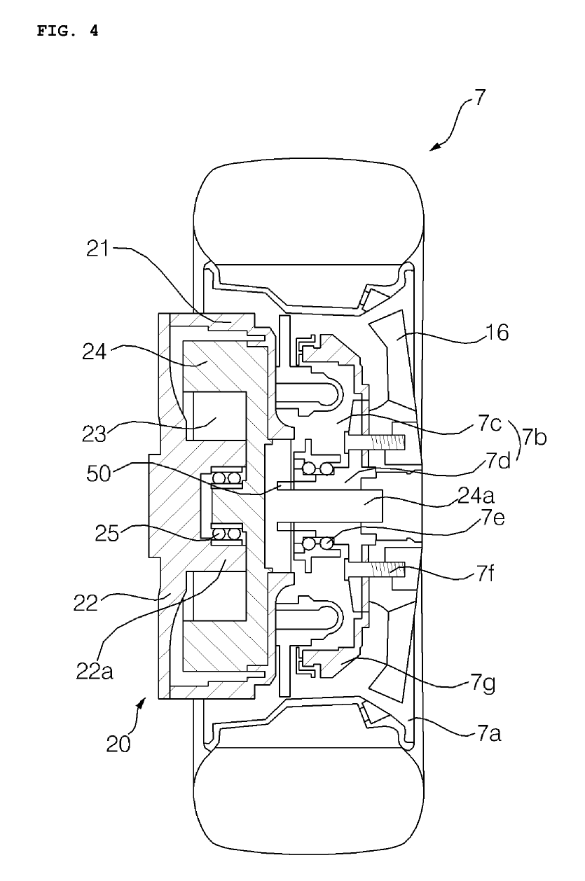

FIG. 4 is an enlarged view of the second vehicle wheel illustrated in FIG. 2.

Referring to FIGS. 2 and 4, the second motor unit 20 includes a second housing 21 which is at least partially inserted into the second wheel 7a, a second rotor 24 which is rotatably disposed in the second housing 21, and a second stator 23 which is disposed in the second rotor 24 and produces the second electricity by using rotational force of the second rotor 24.

In the first motor unit 10, the first rotor 14 is disposed in the first stator 13, but in the second motor unit 20, the second stator is disposed in the second rotor 24. The reason is to increase rotational inertial force by increasing a diameter of the second rotor 24, and thus to easily produce the second electricity by using rotational force of the second rotor 24.

The second housing 21 is formed to have a vacant structure, and the second rotor 24 and the second stator 23 are accommodated in a vacant internal space of the second housing 21. A left side of the second housing 21 is fully opened, and a second cover 22 is coupled to the opened left side. The second cover 22 is coupled to the second housing 21 while covering the opened left side of the second housing 21. The second cover 22 may be coupled to and supported by the second lower arm 3.

When the energy distributor 40 supplies the first electricity to the second motor unit 20, the second rotor 24 is rotated by a magnetic field formed between the second rotor 24 and the second stator 23. A rotating shaft 24a of the second rotor 24 protrudes at left and right sides of the second rotor 24. The rotating shaft 24a of the second rotor 24 may be understood as the same as the rotating shaft 24a of the second motor unit 20.

A left side of the rotating shaft 24a of the second rotor 24 is rotatably coupled to the second cover 22. The left side of the rotating shaft 24a of the second rotor 24 may be rotatably coupled to the second cover 22 by means of a bearing 25. A mounting portion 22a, which protrudes toward the inside of the second housing 21, is formed at a center of the second cover 22. The left side of the rotating shaft 24a of the second rotor 24 is inserted into the mounting portion 22a and rotatably coupled to the mounting portion 22a by the bearing 25, such that the left side of the rotating shaft 24a of the second rotor 24 may be rotatably coupled to the second cover 22. Meanwhile, the second stator 23 may be fixed to an outer circumferential surface of the mounting portion 22a.

A right side of the rotating shaft 24a of the second rotor 24 is coupled to a second hub 7b through a clutch 50. The clutch 50 serves to connect the rotating shaft 24a of the second rotor 24 to the second hub 7b or disconnect the rotating shaft 24a of the second rotor 24 from the second hub 7b. In a state in which the clutch 50 connects the rotating shaft 24a of the second rotor 24 to the second hub 7b, the rotating shaft 24a of the second rotor 24 may receive rotational force from the second hub 7b. Here, the second hub 7b is coupled inside the second wheel 7a by means of bolts 7f, and when the second wheel 7a is rotated by driving power from an internal combustion engine (not illustrated), the second hub 7b is rotated simultaneously together with the second wheel 7a to transmit rotational force of the second wheel 7a to the rotating shaft 24a of the second rotor 24.

The second hub 7b includes a second outer wheel 7c which is fixedly coupled to the second housing 21, and a second inner wheel 7d which is rotatably coupled inside the second outer wheel 7c by means of a bearing 7e. The second inner wheel 7d is coupled to the second wheel 7a by the bolts 7f.

A center at a right side of the second housing 21 is opened. The rotating shaft 24a of the second rotor 24 penetrates the opened right side of the second housing 21, and protrudes toward the outside of the second housing 21 to be inserted into the second inner wheel 7d. The rotating shaft 24a of the second rotor 24, which protrudes toward the outside of the second housing 21, is coupled to the second inner wheel 7d through the clutch 50. Therefore, in a state in which the clutch 50 connects the rotating shaft 24a of the second rotor 24 to the second inner wheel 7d, the second inner wheel 7d is rotated by rotational force transmitted from the second wheel 7a, thereby rotating the second rotor 24.

Meanwhile, when the second inner wheel 7d is coupled to the second wheel 7a by the bolts 7f, the second inner wheel 7d and the second wheel 7a are coupled together with a second brake 7g. That is, a portion of the second brake 7g, which is disposed between the second wheel 7a and the second inner wheel 7d, is coupled by the bolts 7f. When the driver presses the brake pedal, the second brake 7g causes friction with the second outer wheel 7c to brake the second wheel 7a.

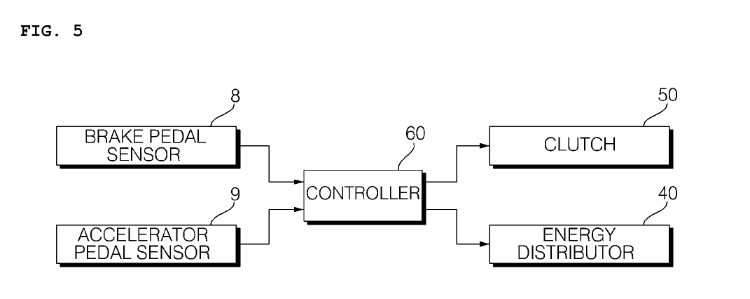

FIG. 5 is a control block diagram illustrating the hybrid vehicle according to the exemplary embodiment of the present invention.

Referring to FIG. 5, the hybrid vehicle according to the exemplary embodiment of the present invention further includes a brake pedal sensor 8 which senses a brake pedal signal, an accelerator pedal sensor 9 which senses an accelerator pedal signal, and a controller 60 which controls the energy distributor 40 and the clutch 50 by using the brake pedal signal sensed by the brake pedal sensor 8 and the accelerator pedal signal sensed by the accelerator pedal sensor 9. Here, the controller 60 may be an electronic control unit (ECU) that is a representative control device in the vehicle. In addition, the controller 60 may have the function of the inverter 30. Hereinafter, the configuration in which the controller 60 has the function of the inverter 30 will be described.

When the driver presses the brake pedal, the brake pedal sensor 8 may sense the brake pedal signal by sensing a position of the brake pedal.

When the driver presses an accelerator pedal, the accelerator pedal sensor 9 may sense the accelerator pedal signal by sensing a position of the accelerator pedal.

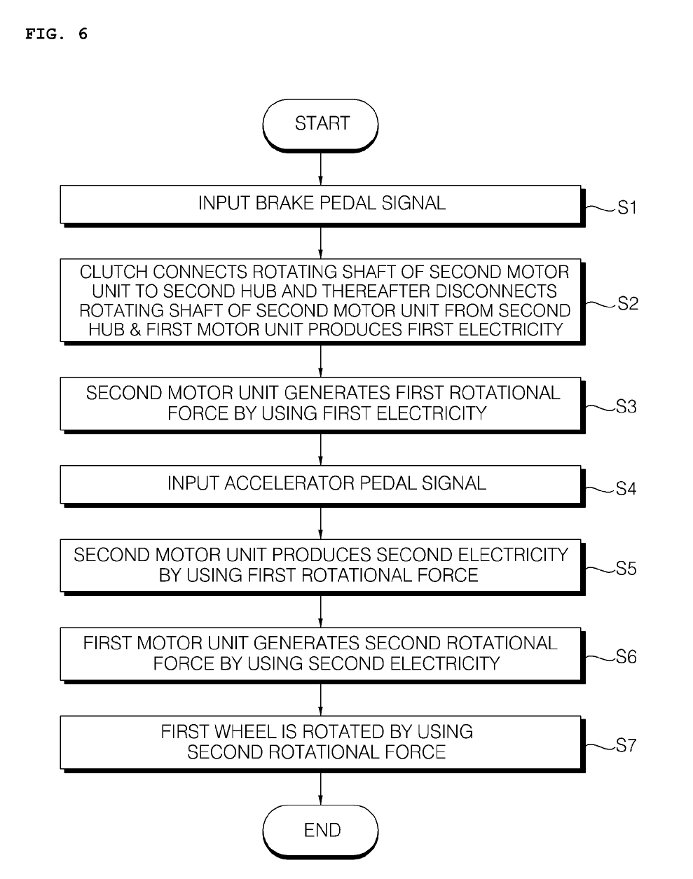

FIG. 6 is a flowchart according to a method of controlling the hybrid vehicle according to the exemplary embodiment of the present invention.

Referring to FIG. 6, when the driver intends to brake the vehicle while the vehicle travels, the driver presses the brake pedal. When the driver presses the brake pedal, the brake pedal sensor 8 senses the brake pedal signal and inputs the brake pedal signal to the controller 60 (S1).

When the brake pedal signal is input, the controller 60 controls the clutch 50 so that the clutch 50 connects the rotating shaft 24a of the second motor unit 20 to the second hub 7b, and thereafter disconnects the rotating shaft 24a of the second motor unit 20 from the second hub 7b. In addition, the controller 60 controls the first motor unit 10 so that the first motor unit 10 produces the first electricity by using regenerative braking force (S2).

The clutch 50 may be a frictional clutch that may be controlled by the controller 60. The frictional clutch includes two plates that causes friction when the two plates come into contact with each other, any one plate of the two plates is coupled to the rotating shaft 24a of the second rotor 24 so as to be slidable in an axial direction, and the other plate is coupled to the second hub 7b. A permanent magnet is coupled to any one plate of the two plates, and an electromagnet is coupled to the other plate of the two plates at a position corresponding to the permanent magnet, such that the electromagnet is controlled by the controller 60 and generates magnetic force that attracts the permanent magnet, and as a result, the plate of the two plates, which is slidably coupled to the rotating shaft 24a of the second rotor 24, slides in the axial direction such that the two plates may cause friction therebetween.

When the clutch 50 connects the rotating shaft 24a of the second motor unit 20 to the second hub 7b, rotational force of the second wheel 7a is transmitted to the rotating shaft 24a of the second motor unit 20 through the second hub 7b, and as a result, the rotating shaft 24a of the second motor unit 20 is rotated. When the clutch 50 disconnects the rotating shaft 24a of the second motor unit 20 from the second hub 7b in a state in which the rotating shaft 24a of the second motor unit 20 is being rotated as described above, the rotating shaft 24a of the second motor unit 20 continues to be rotated by inertial force. Here, the rotation of the rotating shaft 24a of the second motor unit 20 may be understood as the same as the rotation of the second rotor 24.

In a state in which the second rotor 24 of the second motor unit 20 continues to be rotated by inertial force as described above, the controller 60 controls the energy distributor 40 so that the energy distributor 40 supplies the first electricity to the second motor unit 20.

When the energy distributor 40 supplies the first electricity to the second motor unit 20, the second motor unit 20 generates rotational force, which allows the second rotor 24 to be more quickly rotated, by using the first electricity (S3). In this case, the rotational force generated by the second motor unit 20 is referred to as first rotational force. As described above, the second motor unit 20 converts the first electricity, which is electrical energy produced by the first motor unit 10, into the first rotational force that is kinetic energy.

Thereafter, the driver presses the accelerator pedal in order to accelerate the vehicle. When the driver presses the accelerator pedal, the accelerator pedal sensor 9 senses the accelerator pedal signal and inputs the accelerator pedal signal to the controller 60 (S4).

When the accelerator pedal signal is input, the controller 60 controls the second motor unit 20 so that the second motor unit 20 produces the second electricity by using the first rotational force (S5). That is, the second motor unit 20 converts electrical energy produced by the first motor unit 10 into kinetic energy, and when the accelerator pedal signal is input, the second motor unit 20 converts the kinetic energy back into electrical energy. In this case, the controller 60 controls the energy distributor 40 so that the energy distributor 40 supplies the second electricity to the first motor unit 10.

When the energy distributor 40 supplies the second electricity to the first motor unit 10, the first motor unit 10 uses the second electricity and generates rotational force by which the first rotor 14 is rotated (S6). In this case, the rotational force generated by the first motor unit 10 is referred to as second rotational force.

When the first motor unit 10 generates the second rotational force as described above, the first wheel 6a is rotated by using the second rotational force (S7). That is, when the first rotor 14 is rotated by using the second electricity, rotational force of the first rotor 14 is transmitted to the first wheel 6a through the speed reducer 17 and the first hub 6b, such that the first wheel 6a is rotated simultaneously together with the first rotor 14.

As described above, according to the hybrid vehicle according to the exemplary embodiment of the present invention and the method of controlling the hybrid vehicle, the second motor unit 20 generates the first rotational force by using the first electricity generated by the first motor unit 10 for rotating the first wheel 6a, and produces the second electricity, and the first motor unit 10 generates the second rotational force by using the second electricity, and rotates the first wheel 6a, such that it is possible to assist the engine without using a battery.

It may be understood by a person skilled in the art that the present invention may be carried out in other specific forms without changing the technical spirit or the essential characteristics. Thus, it should be appreciated that the exemplary embodiments described above are intended to be illustrative in every sense, and not restrictive. The scope of the present invention is represented by the claims to be described below rather than the detailed description, and it should be interpreted that all the changes or modified forms, which are derived from the meaning and the scope of the claims, and the equivalents thereto, are included in the scope of the present invention.

What is claimed is:

1. A hybrid vehicle comprising:
a first motor unit which rotates a first wheel and produces first electricity; and
a second motor unit which generates first rotational force by using the first electricity, and generates second electricity by using the first rotational force,
wherein the first motor unit generates second rotational force by using the second electricity, and rotates the first wheel.

2. The hybrid vehicle of claim 1, wherein the first motor unit is at least partially disposed in the first wheel.

3. The hybrid vehicle of claim 1, wherein the first motor unit produces the first electricity by using regenerative braking force when the hybrid vehicle is braked while traveling, and generates the second rotational force by using the second electricity to rotate the first wheel when the hybrid vehicle accelerates after being braked, and the second motor unit produces the second electricity when the hybrid vehicle accelerates after being braked, by using the first rotational force that is generated by using the first electricity.

4. The hybrid vehicle of claim 1, further comprising:
an energy distributor which supplies the first electricity to the second motor unit when the hybrid vehicle is braked while traveling, and supplies the second electricity to the first motor unit when the hybrid vehicle accelerates after being braked.

5. The hybrid vehicle of claim 1, wherein the first motor unit includes:
a first housing;
a first stator which is fixed in the first housing; and
a first rotor which is rotatably disposed in the first stator and rotates a first hub coupled inside the first wheel.

6. The hybrid vehicle of claim 5, wherein at least one side of the first housing is opened, the first motor unit further includes a first cover that is coupled to the first housing while covering the opened one side of the first housing, and the first rotor is rotatably coupled to the first cover.

7. The hybrid vehicle of claim 5, wherein the first motor unit further includes:
a speed reducer which is coupled to a rotating shaft of the first rotor and the first hub, increases torque received from the first rotor, and transmits torque to the first hub.

8. The hybrid vehicle of claim 1, wherein the second motor unit includes:
a second housing;
a second rotor which is rotatably disposed in the second housing; and
a second stator which is disposed in the second rotor and produces the second electricity by rotation of the second rotor.

9. The hybrid vehicle of claim 8, wherein at least one side of the second housing is opened, the second motor unit further includes a second cover that is coupled to the second housing while covering the opened one side of the second housing, the second rotor is rotatably coupled to the second cover, and the second stator is fixed to the second cover.

10. The hybrid vehicle of claim 1, wherein the second motor unit is at least partially disposed in a second wheel.

11. The hybrid vehicle of claim 10, wherein the second wheel and the first wheel are disposed in a left and right direction relative to each other.

12. The hybrid vehicle of claim 10, further comprising:
a clutch which connects a rotating shaft of the second motor unit to a second hub coupled inside the second wheel or disconnects the rotating shaft of the second motor unit from the second hub,
wherein in a state in which the clutch connects the rotating shaft of the second motor unit to the second hub, and thereafter disconnects the rotating shaft of the second motor unit from the second hub such that the rotating shaft of the second motor unit is rotated by inertial force, the second motor unit generates the first rotational force by using the first electricity.

13. A method of controlling a hybrid vehicle, the method comprising:
producing, by a first motor unit, first electricity for rotating a first wheel;
generating, by a second motor unit, first rotational force by using the first electricity;
producing, by the second motor unit, second electricity by using the first rotational force; and
generating, by the first motor unit, second rotational force by using the second electricity and rotating the first wheel.

14. The method of claim 13, wherein in the producing of the first electricity, the first electricity is produced by using regenerative braking force when the hybrid vehicle is braked while traveling, and in the producing of the second electricity, the second electricity is produced by using the first rotational force when the hybrid vehicle accelerates after being braked.

15. The method of claim 13, wherein in the generating of the first rotational force, the second motor unit generates the first rotational force by using the first electricity in a state in which a rotating shaft of the second motor unit is connected to a second hub coupled inside the second wheel and thereafter disconnected from the second hub such that the rotating shaft of the second motor unit is rotated by inertial force.
